(19) United States
(12) Patent Application Publication
(10) Pub. No.: US 2026/0106069 A1
(43) Pub. Date: Apr. 16, 2026

(54) COIL COMPONENT

(71) Applicant: SAMSUNG ELECTRO-MECHANICS CO., LTD., Suwon-si (KR)

(72) Inventors: Dong Gun LEE, Suwon-si (KR); Sang Hyeon HONG, Suwon-si (KR); Joung Hee CHO, Suwon-si (KR)

(73) Assignee: SAMSUNG ELECTRO-MECHANICS CO., LTD., Suwon-si (KR)

(21) Appl. No.: 19/213,520

(22) Filed: May 20, 2025

(30) Foreign Application Priority Data
Oct. 11, 2024 (KR) 10-2024-0138296

(51) Int. Cl. H01F 27/29; H01F 27/28; H01F 27/33

(52) U.S. Cl. CPC H01F 27/292; H01F 27/2828; H01F 27/33

(57) ABSTRACT

A coil component includes a body, a coil, and first and second external electrodes. The coil includes a first lead-out portion extending to a first surface of the body and a second lead-out portion extending to a second surface. Each of the first and second external electrodes includes an insertion portion at least partially disposed in the body, an extension portion bent from the insertion portion and extending in a second direction perpendicular to the first surface, and a pad portion bent from the extension portion and extending to a third surface of the body. An average length of each extension portion in the second direction is 0.5 times or less than an average thickness of the body in the second direction and is inversely proportional to a mass of the coil component.

### CROSS-REFERENCE TO RELATED APPLICATION(S)

This application claims benefit of priority to Korean Patent Application No. 10-2024-0138296 filed on Oct. 11, 2024 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with a resistor and a capacitor. A coil may allow the flow of current to be adjusted, removing noise and preventing sudden changes in current, thereby protecting electronic devices.

As electronic devices have gradually been implemented with higher performance and reduced sizes, electronic components used in electronic devices have increased in number and reduced in size.

As the number of electronic devices used in vehicles increases, in particular, the number of electronic devices directly mounted in an engine room, there is demand for inductors having enhanced vibration resistance.

### PRIOR ART DOCUMENT

### Patent Document

Patent Document 1: JP Patent Application Publication No. 2017-045742

### SUMMARY

An aspect of the present disclosure is to provide a coil component having improved vibration resistance by designing an average length of a region of an external electrode exposed to a side surface of a body to have an inverse proportional relationship with a mass of the coil component, thereby avoiding resonance between a natural frequency of the coil component and an operating frequency.

An aspect of the present disclosure is to provide a coil component having improved vibration resistance by designing an average length of a region of an external electrode exposed to a side surface of a body to have a proportional relationship with a cross-sectional area of an external electrode on a plane, perpendicular to a winding axis of a coil, thereby avoiding resonance between a natural frequency of the coil component and an operating frequency.

According to an aspect of the present disclosure, there is provided a coil component including a body having a first surface and a second surface opposing each other in a first direction, and a third surface and a fourth surface opposing each other in a second direction, perpendicular to the first direction, a coil disposed in the body, the coil including a first lead-out portion that extends to the first surface and a second lead-out portion that extends to the second surface, and a first external electrode connected to the first lead-out portion, and a second external electrode connected to the second lead-out portion. The first and second external electrodes may include an insertion portion having at least a portion disposed in the body, an extension portion bent from the insertion portion, the extension portion extending in the second direction, and a pad portion bent from the extension portion, the pad portion extending to the third surface. An average length of the extension portion in the second direction may be 0.5 times or less of an average thickness of the body in the second direction, and may be set to have an inverse proportional relationship with a mass of the coil component.

According to another aspect of the present disclosure, there is provided a coil component including a body having a first surface and a second surface opposing each other in a first direction, and a third surface and a fourth surface opposing each other in a second direction, perpendicular to the first direction, a coil disposed in the body, the coil including a first lead-out portion lead-out to the first surface and a second lead-out portion lead-out to the second surface, and a first external electrode connected to the first lead-out portion, and a second external electrode connected to the second lead-out portion. The first and second external electrodes may include an insertion portion having at least a portion disposed in the body, an extension portion bent from the insertion portion, the extension portion extending in the second direction, and a pad portion bent from the extension portion, the pad portion extending to the third surface. An average length of the extension portion in the second direction may be 0.5 times or less of an average thickness of the body in the second direction, and may be set to have a proportional relationship with a cross-sectional area of the extension portion in a cross-section, perpendicular to the second direction.

A coil component may have improved vibration resistance by designing an average length of a region of an external electrode exposed to a side surface of a body to have an inverse proportional relationship with a mass of the coil component, thereby avoiding resonance between a natural frequency of the coil component and an operating frequency.

The coil component may have improved vibration resistance by designing an average length of a region of an external electrode exposed to a side surface of a body to have a proportional relationship with a cross-sectional area of an external electrode on a plane, perpendicular to a winding axis of a coil, thereby avoiding resonance between a natural frequency of the coil component and an operating frequency.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a coil component according to a first exemplary embodiment of the present disclosure;

FIG. 2 is a bottom view of FIG. 1;

FIG. 3 is a schematic diagram illustrating a process of forming a coil and an external electrode of a coil component according to a first exemplary embodiment of the present disclosure;

FIG. 4 is an exploded perspective view of FIG. 1;

FIG. 5 is a cross-sectional view taken along line I-I′ of FIG. 1;

FIG. 6 is a cross-sectional view taken along line II-II′ of FIG. 1;

FIG. 7 is a schematic perspective view of a coil component according to a second exemplary embodiment of the present disclosure;

FIG. 8 is a schematic diagram illustrating a process of forming a coil and an external electrode of a coil component according to a second exemplary embodiment of the present disclosure;

FIG. 9 is a cross-sectional view taken along line III-III′ of FIG. 7;

FIGS. 10 to 12 are graphs illustrating an average length of an extension portion according to a mass of a coil component when the average thickness of the extension portion is 0.15 mm; and

FIGS. 13 to 15 are graphs illustrating an average length of the extension portion according to a mass of a coil component when the average thickness of the extension portion is 0.2 mm.

### DETAILED DESCRIPTION

Terminology used herein is for the purpose of describing particular exemplary embodiments only and is not to be limiting of the exemplary embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean the element is positioned on or below a target portion, and does not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not limited to those illustrated herein.

In the drawings, an L-direction may be defined as a first direction or a length direction, a W-direction may be defined as a second direction or a width direction, and a T-direction may be defined as a third direction or a thickness direction.

Hereinafter, a coil component according to an exemplary embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

### First Example Embodiment

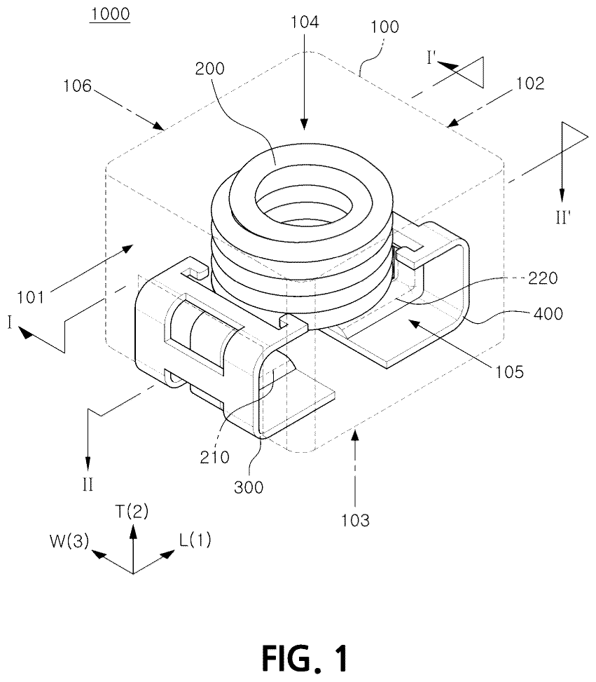

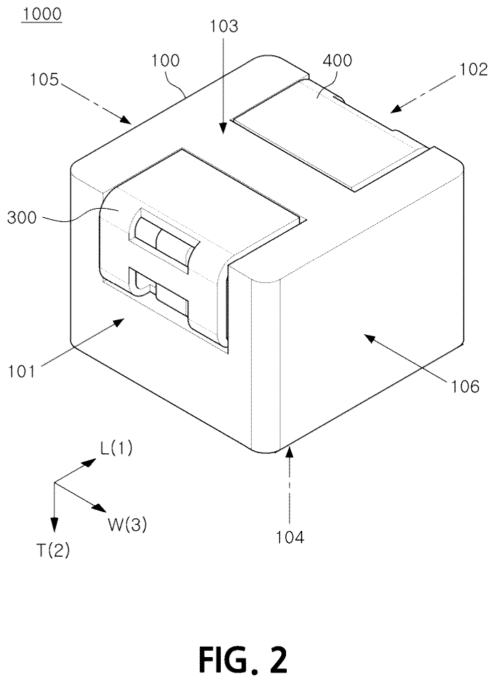

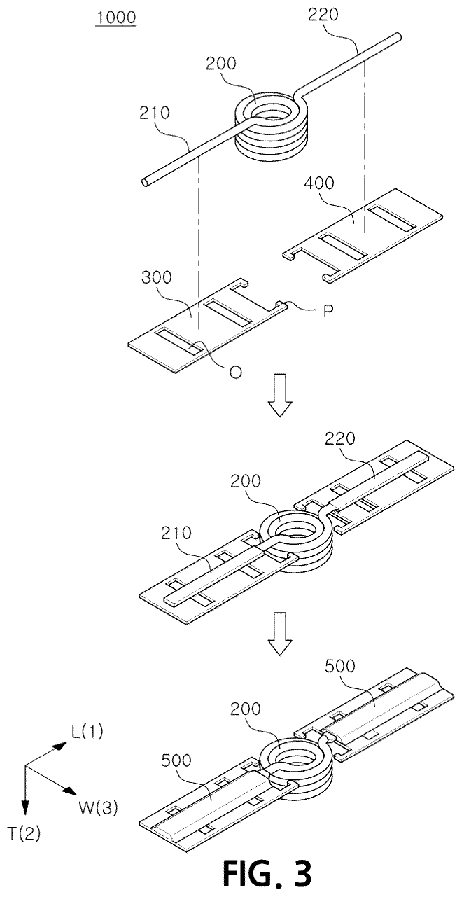

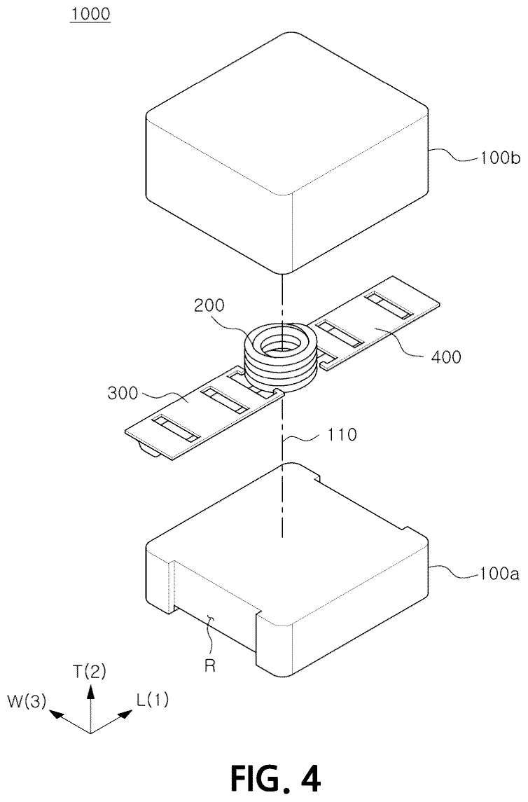

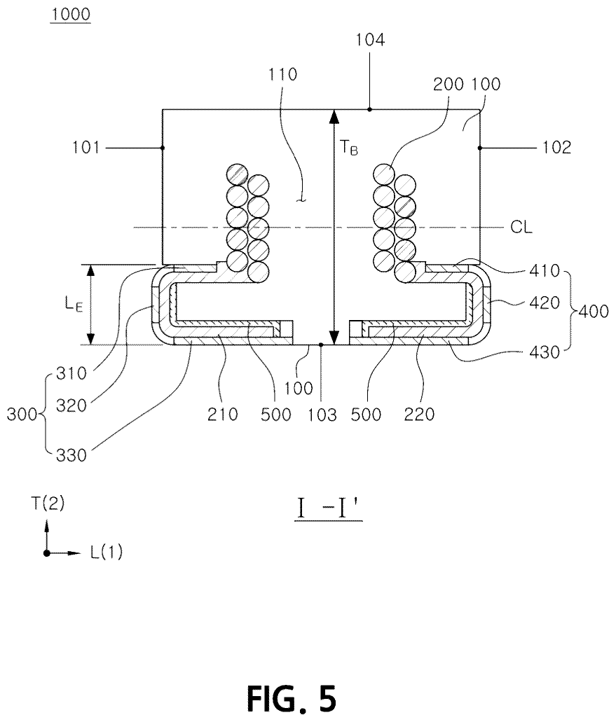

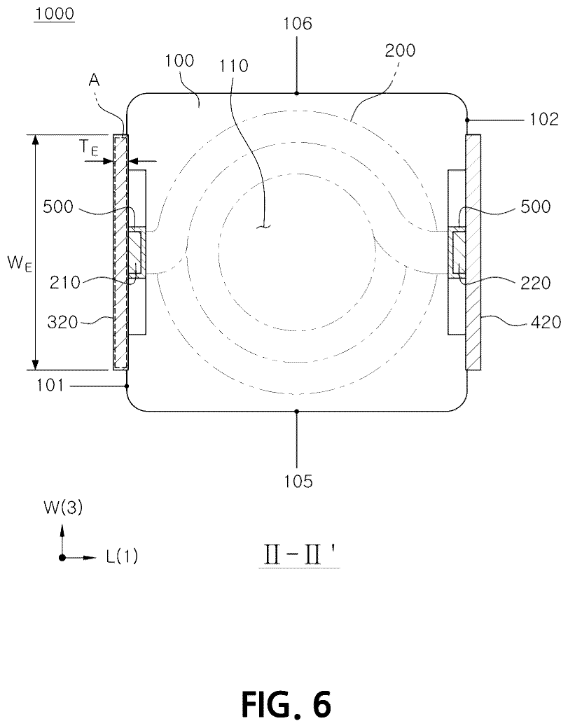

FIG. 1 is a schematic perspective view of a coil component according to a first exemplary embodiment of the present disclosure. FIG. 2 is a bottom view of FIG. 1. FIG. 3 is a schematic diagram illustrating a process of forming a coil and an external electrode of a coil component according to a first exemplary embodiment of the present disclosure. FIG. 4 is an exploded perspective view of FIG. 1. FIG. 5 is a cross-sectional view taken along line I-I′ of FIG. 1. FIG. 6 is a cross-sectional view taken along line II-II′ of FIG. 1.

In FIGS. 1 to 6, an insulating layer on a body 100, applicable to the present exemplary embodiment, is omitted and illustrated in order to more clearly illustrate bonding between elements.

Referring to FIGS. 1 to 6, a coil component 1000 according to a first exemplary embodiment of the present disclosure may include a body 100, a coil 200, and external electrodes 300 and 400, and may further include lead-out portions 210 and 220 included in both ends of the coil 200, and a metal layer 500 covering the lead-out portions 210 and 220.

Unlike a structure in which the external electrodes 300 and 400 are plated on the body 100, the coil component 1000 according to the present exemplary embodiment may have a structure in which the external electrodes 300 and 400 are separately formed using a frame such as a metal plate, the body 100 is formed in a state of being coupled to the coil 200 such as a winding wire, and the external electrodes 300 and 400 are bent to surround a side surface and a lower surface of the body 100.

When the coil component 1000 according to the present exemplary embodiment is mounted on a circuit board and used, the coil component 1000 may be exposed to vibrations depending on a usage environment. For example, there is a risk of resonance occurring between an operating frequency range of 10 to 2000 kHz, specified by standard regulations such as AEC-Q200 for automotive electronic components, and a natural frequency of the coil component.

Accordingly, in the coil component 1000 according to the present example embodiment, extension portions 320 and 420, regions of the external electrodes 300 and 400 disposed on the side surface of the body 100, may be disposed in a low position through a low-centered design, and an average length of each of the extension portions 320 and 420 may be appropriately set to have a predetermined relationship with a mass of the coil component 1000 or a cross-sectional area of each of the extension portions 320 and 420, such that the natural frequency of the coil component 1000 mounted on the circuit board may deviate from the operating frequency range, and accordingly the coil component 1000 mounted on the circuit board may have enhanced vibration resistance.

Hereinafter, main elements included in the coil component 1000 according to the present exemplary embodiment will be described in detail.

The body 100 may form the exterior of the coil component 1000 according to the present example embodiment, and may include the coil 300 buried therein.

The body 100 may have an overall hexahedral shape.

The body 100 may have a first surface 101 and a second surface 102 opposing each other in a length direction L (first direction), a third surface 103 and a fourth surface 104 opposing each other in a thickness direction T (second direction), and a fifth surface 105 and a sixth surface 106 opposing each other in a width direction W (third direction). Each of the first surface 101, the second surface 102, the fifth surface 105, and the sixth surface 106 of the body 100 may correspond to a wall surface of the body 100 connecting the third surface 103 and the fourth surface 104 to each other.

Referring to FIGS. 1 and 5, an average thickness (T_{B}) of the body 100 in the second direction T may be, for example, within a range of 3 mm to 6 mm, but the present disclosure is not limited thereto. The above-described exemplary dimensions of the average thickness (T_{B}) may refer to dimensions not reflecting process variations. Accordingly, any dimensions that fall within a range recognized as manufacturing tolerances should be considered as corresponding to the above-described exemplary dimensions.

With respect to an optical microscope or scanning electron microscope (SEM) image of a cross-section in the length direction L and the thickness direction T obtained by cutting a central portion of the body 100 in the width direction W, the above-described average thickness (T_{B}) of the body 100 may refer to an arithmetic mean value of at least three dimensions, among dimensions of each of a plurality of line segments connecting, to each other, two outermost boundary lines of the body 100 opposing each other in the thickness direction T illustrated in the image, to be parallel to the thickness direction T, the plurality of line segments spaced apart from each other in the length direction L. Here, the plurality of line segments, parallel to the thickness direction T, may be equally spaced from each other in the length direction L, but the present disclosure is not limited thereto.

Alternatively, the average thickness (T_{B}) of the body 100 may be measured using a micrometer measurement method. The average thickness (T_{B}) of the body 100 may be measured by setting a zero point with a gage repeatability and reproducibility (R&R) micrometer, inserting the body 100 into a space between tips of the micrometer, and turning a measurement lever of the micrometer. In measuring the average thickness (T_{B}) of the body 100 using the micrometer measurement method, the average thickness (T_{B}) of the body 100 may refer to an arithmetic mean of values measured multiple times.

The body 100 may include a magnetic material and a resin. The body 100 may be formed by filling a mold with a magnetic material, and may be formed by filling the mold with a composite material including a magnetic material and a resin. A molding process of applying high temperature and high pressure to a magnetic material or a composite material in a mold may be additionally performed, but the present disclosure is not limited thereto.

Referring to FIG. 3, in the body 100, for example, bodies 100a and 100b, two upper and lower regions of the coil 200, may be separately formed, and may be coupled to each other to form a single body 100. In this case, the bodies 100a and 100b, the two upper and lower regions, may have different densities according to formation temperature or pressure, and elements included in the bodies 100a and 100b may be partially different from each other, but the present disclosure is not limited thereto.

The magnetic material included in the body 100 may be ferrite powder particles or metal magnetic powder particles.

The ferrite powder particles may be, for example, at least one of spinel-type ferrite powder particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite powder particles such as Ba—Zn-based ferrite powder particles, Ba—Mg-based ferrite powder particles, Ba—Ni-based ferrite powder particles, Ba—Co-based ferrite powder particles, Ba—Ni —Co-based ferrite powder particles, or the like, garnet-type ferrite powder particles such as Y-based ferrite powder particles or the like, and Li-based ferrite powder particles.

The magnetic metal powder particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si —Al-based alloy powder particles, Fe—Ni-based alloy powder particles, Fe—Ni —Mo-based alloy powder particles, Fe—Ni —Mo—Cu-based alloy powder particles, Fe—Co-based alloy powder particles, Fe—Ni —Co-based alloy powder particles, Fe—Cr-based alloy powder particles, Fe—Cr —Si-based alloy powder particles, Fe—Si —Cu—Nb-based alloy powder particles, Fe—Ni —Cr-based alloy powder particles, and Fe—Cr —Al-based alloy powder particles.

The magnetic metal powder particles may be amorphous or crystalline. For example, the magnetic metal powder particles may be Fe—Si —B—Cr-based amorphous alloy powder particles, but the present disclosure is not limited thereto.

Each of the ferrite powder particles and the magnetic metal powder particles may have an average diameter of about 0.1 μm to about 30 μm, but the present disclosure is not limited thereto.

The body 100 may include two or more types of magnetic materials dispersed in the resin. Here, different types of magnetic materials mean that the magnetic materials dispersed in the resin are distinguished from each other by one of an average diameter, a composition, crystallinity, and a shape.

The resin may include epoxy, polyimide, a liquid crystal polymer, or the like alone or in combination, but the present disclosure is not limited thereto.

The body 100 may include a core 110. The core 110 may refer to a region of the body 100 charged to pass through an air core of the coil 200. The core 110 may be disposed in an internal region of the coil 200 forming at least one turn, and a cross-section of the core 110 may have a circular shape or an oval shape in a cross-section, perpendicular to a winding axis of the coil 200, but the present disclosure is not limited thereto.

Referring to FIGS. 1 and 4, a recess R may be formed in each of a region in which the first surface 101 and the third surface 103 of the body 100 are connected to each other and a region in which the second surface 102 and the third surface 103 of the body 100 are connected to each other.

The recess R according to the present exemplary embodiment may correspond to a region in which a step portion is formed toward the inside of the body 100 to accommodate the lead-out portions 210 and 220 and the external electrodes 300 and 400. For ease of description, a region in which the recess R is formed may also be defined as being included in the first surface 101, the second surface 102, and the third surface 103.

The extension portions 320 and 420 of the external electrodes 300 and 400 may be disposed in the recess R formed in the first surface 101 and the second surface 102, and the pad portions 330 and 430 of the external electrodes 300 and 400 may be disposed in the recess R formed in the third surface 103.

The lead-out portions 210 and 220 and the external electrodes 300 and 400 according to the present exemplary embodiment may not have the recess R, and may thus be disposed to protrude from a flat surface of the body 100, but the present disclosure is not limited thereto.

The coil 200 may be disposed in the body 100 to exhibit the characteristics of the coil component 1000. For example, when the coil component 1000 according to the present exemplary embodiment is used as a power inductor, the coil 200 may store an electric field as a magnetic field to maintain an output voltage, thereby stabilizing power of an electronic device.

Referring to FIGS. 1, and 4 to 6, the coil 200 may form at least one turn around the core 110, and may include lead-out portions 210 and 220 at both ends of an outermost turn. Specifically, the coil 200 may include a first lead-out portion 210 that extends to the first surface 101 of the body 100, and a second lead-out portion 220 that extends to the second surface 102 of the body 100.

The first lead-out portion 210 may be disposed between the body 100 and the first external electrode 300, and the second lead-out portion 220 may be disposed between the body 100 and the second external electrode 400. The first lead-out portion 210 may extend along a surface of the recess R formed in the first and third surfaces 101 and 103 of the body 100, and the second lead-out portion 220 may extend along a surface of the recess R formed in the second and third surfaces 102 and 103 of the body 100.

Referring to FIGS. 3 and 5, the lead-out portions 210 and 220 may be formed by rolling both ends of the coil 200, and may be flat due to rolling. That is, a thickness of each of the lead-out portions 210 and 220 may be less than a diameter of the coil 200, and a width of a surface of each of the lead-out portions 210 and 220 in contact with each of the external electrodes 300 and 400 may be greater than the diameter of the coil 200.

The lead-out portions 210 and 220 and the external electrodes 300 and 400 may have a surface-contact structure therebetween as described above, such that a contact area between the lead-out portions 210 and 220 and the external electrodes 300 and 400 may be increased, thereby improving bonding reliability and improving Rdc characteristics.

The coil 200 according to the present exemplary embodiment may correspond to an air-core coil and may be a wound-type coil, but the present disclosure is not limited thereto. A region of the coil 200, excluding the lead-out portions 210 and 220, which are connected to the external electrodes 300 and 400, may be coated with an insulating material. Accordingly, a surface of each turn of the coil 200 may be coated with an insulating material, such that insulating properties may be maintained even after winding.

Specifically, the coil 200 may be formed by winding a metal wire having a surface coated with an insulating material in a spiral shape. The metal wire may be a copper wire, but the present disclosure is not limited thereto.

The coil component 1000 according to the present exemplary embodiment illustrates a case in which the coil 200 is formed using a circular wire, but the present disclosure is not limited thereto. When the coil 200 is formed using a metal wire that is a flat line, each turn of the coil 200 may have a rectangular cross-section.

The coil 200 according to the present exemplary embodiment may include a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof, but the present disclosure is not limited thereto.

Referring to FIGS. 1 to 6, the coil component 1000 according to the present exemplary embodiment may include external electrodes 300 and 400 disposed in a body 100, the external electrodes 300 and 400 connected to the coil 200.

The external electrodes 300 and 400 may electrically connect the coil component 1000 and the circuit board to each other when the coil component 1000 according to the present exemplary embodiment is mounted on the circuit board or the like. For example, the first and second external electrodes 300 and 400, disposed on the third surface 103 of the body 100 to be spaced apart from each other, may be electrically connected to a connection portion of the circuit board.

Specifically, the first external electrode 300 may be disposed on the first surface 101 of the body 100 to be in contact with the first lead-out portion 210 that extends to the first surface 101 of the body 100, and the second external electrode 400 may be disposed on the second surface 102 of the body 100 to be in contact with the second lead-out portion 220 extending to the second surface 102 of the body 100.

Referring to FIGS. 1 and 5, the first and second external electrodes 300 and 400 may include insertion portions 310 and 410 having at least a portion disposed in the body 100, extension portions 320 and 420 bent from the insertion portions 310 and 410, the extension portions 320 and 420 extending in the second direction T, and pad portions 330 and 430 bent from the extension portions 320 and 420, the pad portions 330 and 430 extending to the third surface 103 of the body 100.

Here, the insertion portions 310 and 410, the extension portions 320 and 420, and the pad portions 330 and 430 may be integrally formed. For ease of description, the external electrodes 300 and 400 may be divided into regions, and the regions may be defined as the insertion portions 310 and 410, the extension portions 320 and 420, and the pad portions 330 and 430.

Referring to FIGS. 3 and 5, at least portions of the insertion portions 310 and 410 may be inserted into the body 100, and may be in contact with the lead-out portions 210 and 220. The insertion portions 310 and 410 may serve to fix the external electrodes 300 and 400 to the body 100, and may include a protrusion portion P at an inner end thereof.

The protrusion portion P may perform an anchoring function in the body 100 to further enhance bonding force of the external electrodes 300 and 400 with the body 100. The protrusion portion P may have a shape protruding from the inner end of each of the insertion portions 310 and 410 in the third direction W, but the present disclosure is not limited thereto. A protrusion direction or protrusion shape of the protrusion portion P may be formed in various manners. In addition, the protrusion portion P may be formed at both sides of the inner end of each of the insertion portions 310 and 410, or may be formed only at one side of the inner end of each of the insertion portions 310 and 410.

Referring to FIGS. 1 and 5, the extension portions 320 and 420 may be bent from the insertion portions 310 and 410 and extend in the second direction T. The coil component 1000 according to the present exemplary embodiment may be designed to have a low center to improve vibration resistance, and an average length (L_{E}) of each of the extension portions 320 and 420 in the second direction T may be 0.5 times or less of an average thickness (T_{B}) of the body 100 in the second direction T. That is, referring to FIG. 5, when a virtual centerline CL, passing through the center of the body 100 and parallel to the first direction L, is assumed, the extension portions 320 and 420 may be disposed to be close to the third surface 103 that is a mounting surface with respect to the centerline CL.

Referring to FIGS. 4 and 5, the extension portion 320 of the first external electrode 300 may be disposed in the recess R formed in the first surface 101 of the body 100, and the extension portion 420 of the second external electrode 400 may be disposed in the recess R formed in the second surface 102 of the body 100.

When the coil component 1000 according to the present example embodiment is mounted on the circuit board, the extension portions 320 and 420, supporting both side surfaces of the body 100, may be equivalently substituted with a type of spring in relation to vibrations generated. Accordingly, referring to FIGS. 5 and 6, the average length (L_{E}) of each of the extension portions 320 and 420 may be appropriately designed according to a mass of the coil component 1000 or a cross-sectional area (A) of each of the extension portions 320 and 420 in a cross-section, perpendicular to the second direction T, thereby reducing the risk of resonance occurring when a natural frequency of the coil component 1000 corresponds to an operating frequency.

Referring to FIG. 5, in the coil component 1000 according to the present exemplary embodiment, the average thickness (T_{B}) of the body 100 in the second direction T may be 3 mm or more and 6 mm or less. The average length (L_{E}) of each of the extension portions 320 and 420 in the second direction T may be 1 mm or more and 2 mm or less. Considering a manufacturing process of forming the extension portions 320 and 420 by bending, two times, the external electrodes 300 and 400 in the form of a metal plate, it may be difficult to manufacture the extension portions 320 and 420 having an average length (L_{E}) of less than 1 mm. Considering a low-centered design for improving vibration resistance, it may not be preferable to manufacture the extension portions 320 and 420 having an average length (L_{E}) of greater than 2 mm. In addition, the average length (L_{E}) of each of the extension portions 320 and 420 in the second direction T may be 0.5 times or less than the average thickness (T_{B}) of the body 100 in the second direction T. Accordingly, preferably, a ratio ((L_{E}/T_{B}) of the average length (L_{E}) of each of the extension portions 320 and 420 in the second direction T to the average thickness (T_{B}) of the body 100 in the second direction T may be 0.17 or more and 0.5 or less, but the present disclosure is not limited thereto.

Here, referring to FIG. 5, with respect to an optical microscope or SEM image of a cross-section in the length direction L and the thickness direction T obtained by cutting a central portion of the coil component 1000 in the width direction W, the average length (L_{E}) of each of the extension portions 320 and 420 may refer to an arithmetic mean value of at least three dimensions, among dimensions of each of a plurality of line segments connecting, to each other, two outermost boundary lines of each of the extension portions 320 and 420 opposing each other in the second direction T illustrated in the image, to be parallel to the second direction T, the plurality of line segments spaced apart from each other in the first direction L. The plurality of line segments may be equally spaced apart from each other in the second direction T, but the present disclosure is not limited thereto. An average thickness (T_{E}) and an average width (W_{E}) of each of the extension portions 320 and 420 may also be measured in a similar manner to the average length (L_{E}).

In addition, the cross-sectional area (A) of each of the extension portions 320 and 420 in the cross-section (L-W cross-section), perpendicular to the second direction T may be defined as a product of an average thickness (T_{E}) of each of the extension portions 320 and 420 in the first direction L and an average width (W_{E}) of each of the extension portions 320 and 420 in the third direction W in the cross-section, perpendicular to the second direction T, referring to FIG. 6. As another example for measuring the cross-sectional area (A) of each of the extension portions 320 and 420, with respect to an optical microscope or SEM image of a cross-section, parallel to the third surface 103 of the body 100 and passing through the center of the body 100, a cross-sectional area of each of the extension portions 320 and 420 illustrated in the image may be calculated using the Image J program tool, but the present disclosure is not limited thereto.

The average length (L_{E}) of each of the extension portions 320 and 420 in the second direction T may be set to have an inverse proportional relationship with the mass of the coil component 1000. In addition, the average length (L_{E}) of each of the extension portions 320 and 420 in the second direction T may be set to have an inverse proportional relationship with the mass of the coil component 1000. In addition, the average length (L_{E}) of each of the extension portions 320 and 420 in the second direction T may be set to have a proportional relationship with the cross-sectional area (A) of each of the extension portions 320 and 420 in the cross-section (L-W cross-section), perpendicular to the second direction T. As a result, the average length (L_{E}) of each of the extension portions 320 and 420 in the second direction T may be designed to satisfy Equation 1 below.

$${L}_{E} = \frac{E}{4 {π}^{2} \times {f}^{2}} \times \frac{2 A}{m} \qquad [ Equation 1 ]$$

In Equation 1, L_{E} may be defined as an average length of each of the extension portions 320 and 420 in the second direction T, E may be defined as an elastic modulus of each of the extension portions 320 and 420, f may be defined as a natural vibration frequency of the coil component 1000, A may be defined as a cross-sectional area of each of the extension portions 320 and 420 in an L-W cross-section, and m may be defined as a mass of the coil component 1000.

Here, the natural frequency (f) may be set to be greater than 0.2 MHz. Preferably, the natural frequency f may be set to have a value of 0.35 MHz or more and 0.6 MHz or less, but the present disclosure is not limited thereto.

This may be to enhance vibration resistance by reducing the risk of resonance through the design of the coil component 1000 to have a natural frequency higher than an operating frequency range of 10 to 2000 kHz, specified by standard regulations such as AEC-Q200 for automotive electronic components.

In addition, an elastic modulus (E) of each of the extension portions 320 and 420 in Equation 1 may be set to 128 GPa, but the present disclosure is not limited thereto.

Equation 1 may be a result of respectively replacing the extension portions 320 and 420 with two springs connected in parallel to each other and applying Hook's law to derive a natural frequency under a vibration environment when the coil component 1000 according to the present exemplary embodiment is mounted on the circuit board.

First, an amount of spring deformation (δ) may be proportional to a spring length (l) and an external force (F), and may be inversely proportional to the cross-sectional area (A), and thus may be represented by Equations 2 and 3 below.

$$δ ∝ \frac{l}{A} \times F \qquad [ Equation 2 ]$$

$$F ∝ \frac{A}{l} \times δ \qquad [ Equation 3 ]$$

By inserting the elastic modulus (E) of the extensions 320 and 420 and the spring constant (k) as proportionality constants in Equation 3, Equations 4 to 6 below may be derived.

$$F = E \times \frac{A}{l} \times δ \qquad [ Equation 4 ]$$

$$F = k \times δ \qquad [ Equation 5 ]$$

$$k = E \times \frac{A}{l} \qquad [ Equation 6 ]$$

The extension portions 320 and 420 of the coil component 1000 according to the present exemplary embodiment may be equivalently substituted with two springs connected in parallel to each other, and thus may be represented by Equation 7 below.

$$k = E \times \frac{2 A}{l} \qquad [ Equation 7 ]$$

Using the relationship between the natural frequency (f) and the mass (m) and the spring constant (k) of the coil component 1000, the following Equation 10 may be derived from Equation 7.

$$f = \frac{1}{2 π} \sqrt{\frac{k}{m}} \qquad [ Equation 8 ]$$

$$f = \frac{1}{2 π} \sqrt{\frac{E \times 2 A}{m \times l}} \qquad [ Equation 9 ]$$

$$l = \frac{E}{4 {π}^{2} \times {f}^{2}} \times \frac{2 A}{m} \qquad [ Equation 10 ]$$

Accordingly, when the spring length (1) of Equation 10 is substituted with the average length (L_{E}) of each of the extension portions 320 and 420 in the second direction T according to the present exemplary embodiment, a relational expression similar to Equation 1 described above may be derived.

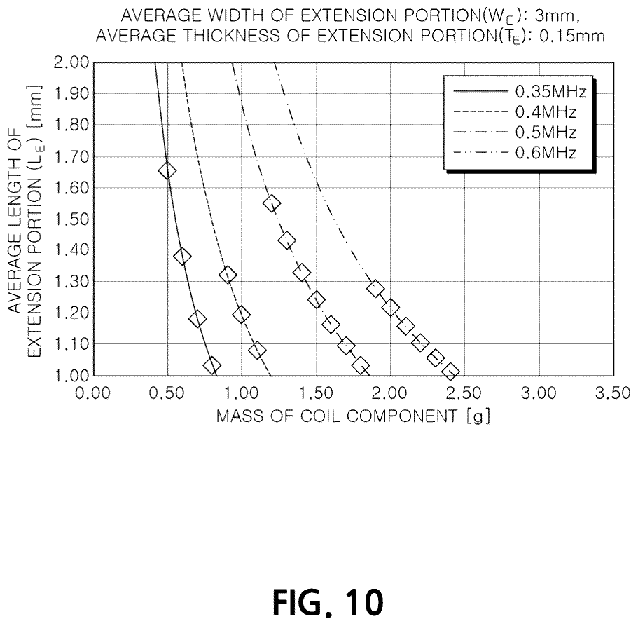

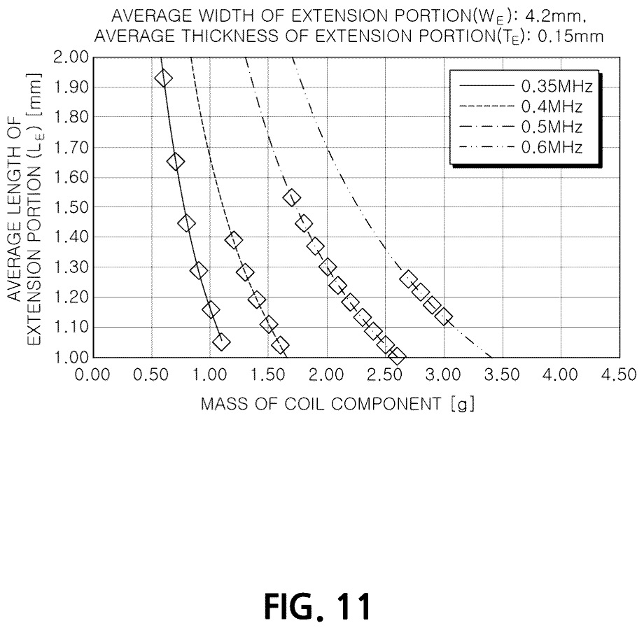

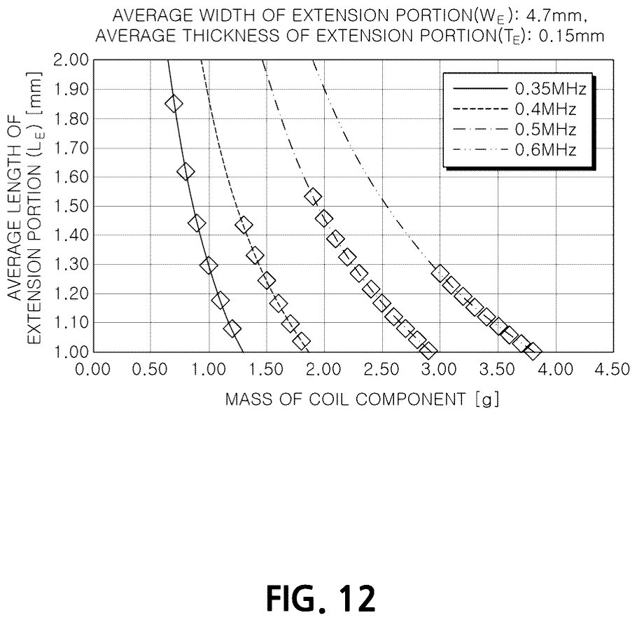

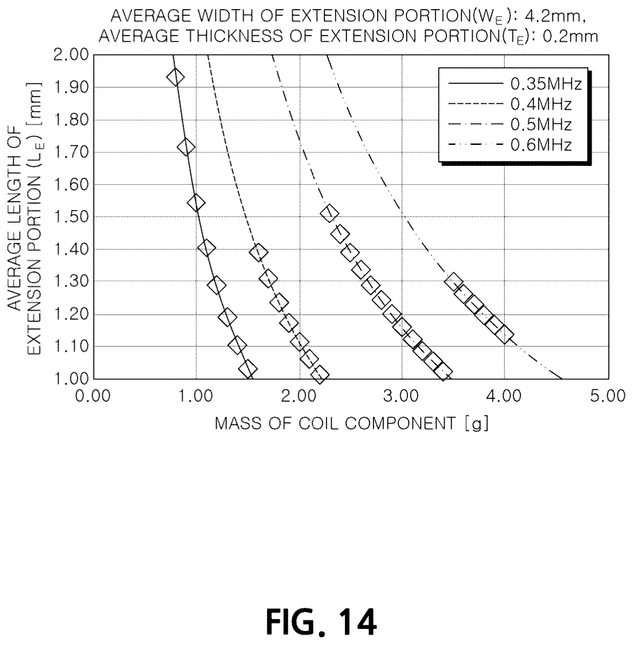

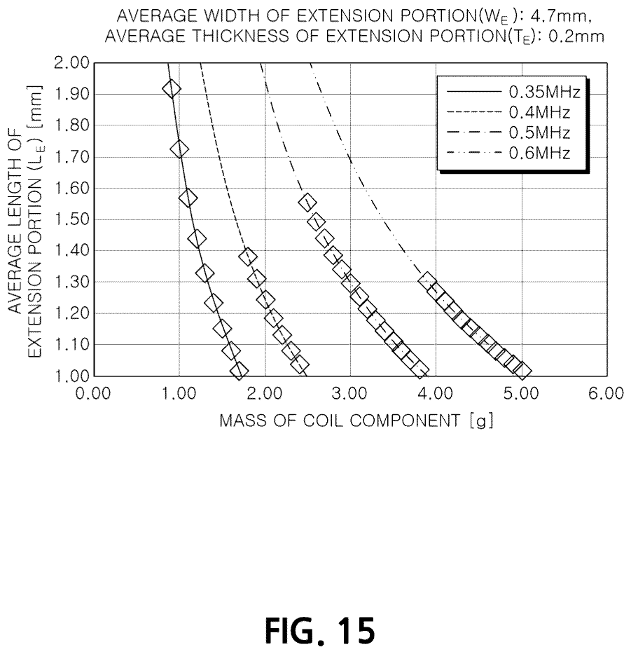

In this regard, specific experimental data will be described below with reference to FIGS. 10 to 15.

Referring to FIGS. 1, 2, and 5, the pad portions 330 and 430 may be bent from the extension portions 320 and 420, and may extend to the third surface 103 of the body 100. The pad portions 330 and 430 may extend in the first direction L, and may be disposed in the recess R formed in the third surface 103 of the body 100.

The pad portions 330 and 430 may be connected to the connection portion of the circuit board when the coil component 1000 according to the present example embodiment is mounted on the circuit board. For example, a bonding member, such as solder, may be disposed between the pad portions 330 and 430 and the connection portion of the circuit board, such that the coil component 1000 and the circuit board may be electrically connected to each other.

Referring to FIGS. 1 and 3, the external electrodes 300 and 400 according to the present exemplary embodiment may further include an opening O formed in at least a portion of a bent region between the insertion portions 310 and 410 and the extension portions 320 and 420 and a bent region between the extension portions 320 and 420 and the pad portions 330 and 430.

The opening O may pass through the external electrodes 300 and 400, and a load may be reduced during a process of bending the external electrodes 300 and 400, thereby preventing damage to the external electrodes 300 and 400. When the external electrodes 300 and 400 have sufficient rigidity to withstand a load generated during a bending process, the opening O may be omitted.

The external electrodes 300 and 400 according to the present exemplary embodiment may include a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof, and may be formed in multiple layers, but the present disclosure is not limited thereto. In addition, the external electrodes 300 and 400 may be fixed to the frame through a rolling process, but the present disclosure is not limited thereto.

Although not illustrated, the coil component 1000 according to the present exemplary embodiment may further include an insulating layer covering a surface of the body 100.

The insulating layer may be formed by methods such as printing, vapor deposition, spray coating, or film lamination, but the present disclosure is not limited thereto.

The insulating layer may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOx or SiNx. The insulating layer may further include an insulating filler such as an inorganic filler, but the present disclosure is not limited thereto.

### Process of Manufacturing Coil Component

Referring to FIG. 3, in the coil component 1000 according to the present example embodiment, the external electrodes 300 and 400 may be first formed on the frame, and the coil 200 may be disposed on the external electrodes 300 and 400. Here, the protrusions P and the openings O may be formed in advance on the external electrodes 300 and 400 before the external electrodes 300 and 400 are coupled to the coil 200, and the lead-out portions 210 and 220 at both ends of the coil 200 may be coupled to the external electrodes 300 and 400 after an insulating layer on a surface of the lead-out portions 210 and 220 is removed and rolled.

After the coil 200 is disposed on the external electrodes 300 and 400, the metal layer 500 may cover the coil 200 for bonding. The metal layer 500 may include at least one of nickel (Ni), tin (Sn), and copper (Cu), and may be formed in multiple layers. The metal layer 500 may be formed through processes such as dipping, soldering; however, the present disclosure is not limited thereto.

Referring to FIG. 4, based on the combined configuration of coil 200 and external electrodes 300 and 400 formed in FIG. 3, a single body 100 may be formed by pressing and curing two regions 100a and 100b of the body 100 in a vertical direction, respectively. In FIG. 4, the directions of FIG. 3 may be vertically inverted, and a portion of an upper region 100a of the body 100 may fill an air core of the coil 200 in the direction of FIG. 4 to form the core 110, but the present disclosure is not limited thereto.

Referring to FIGS. 4 and 5, after the body 100 is formed, in a configuration in which the lead-out portions 210 and 220, the external electrodes 300 and 400, and the metal layer 500 are coupled to each other may be bent once in the second direction T and then bent once again in the first direction L. As a result, the insertion portions 310 and 410, the extension portions 320 and 420, and the pad portions 330 and 430 of the external electrodes 300 and 400 may be formed.

### Second Example Embodiment

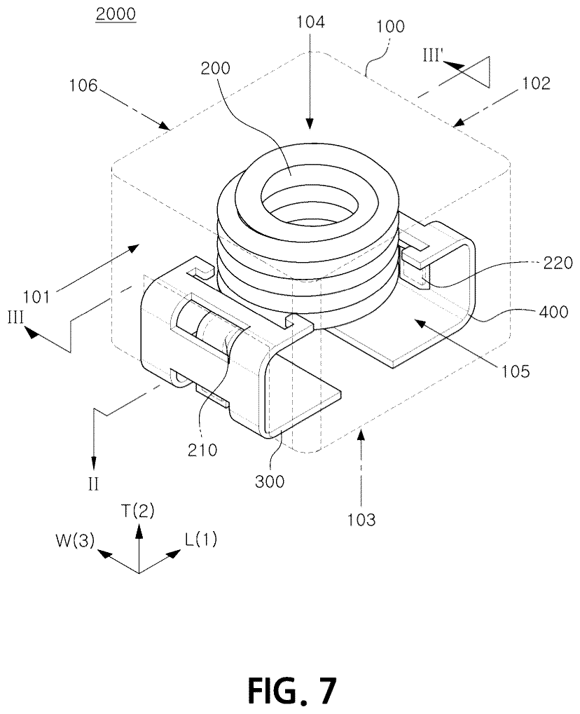

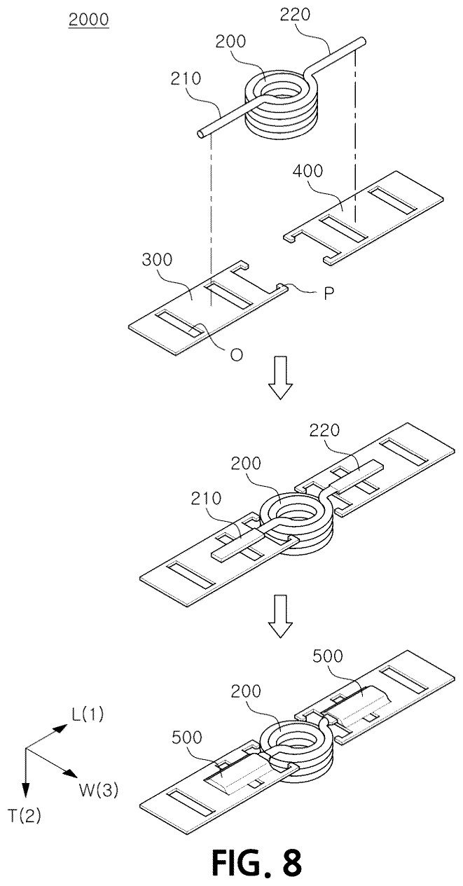

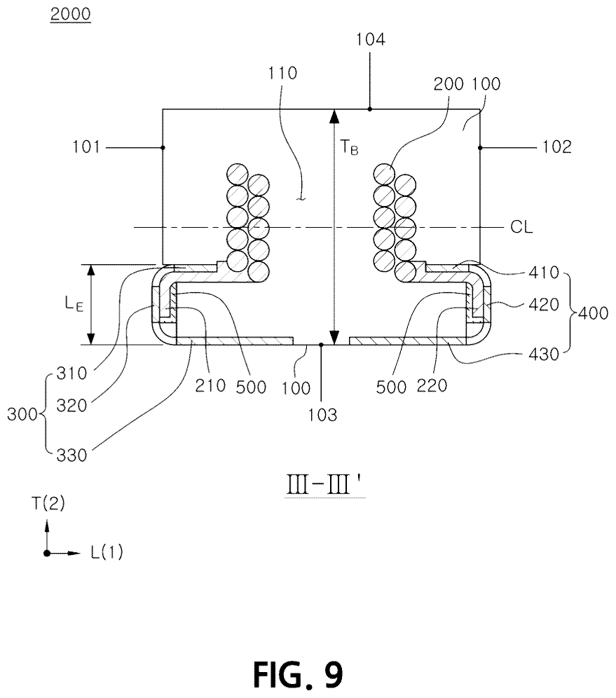

FIG. 7 is a schematic perspective view of a coil component according to a second exemplary embodiment of the present disclosure. FIG. 8 is a schematic diagram illustrating a process of forming a coil and an external electrode of a coil component according to a second exemplary embodiment of the present disclosure. FIG. 9 is a cross-sectional view taken along line III-III′ of FIG. 7.

When FIGS. 7, 8, and 9 are compared with FIGS. 1, 3, and 5, respectively, a coil component 2000 according to the present exemplary embodiment may be different from the coil component 1000 in that first and second lead-out portions 210 and 220 extend only to first and second surfaces 101 and 102 of a body 100, respectively, and do not extend to a third surface 103 of the body 100.

Accordingly, in describing the present example embodiment, only a shape and arrangement of the lead-out portions 210 and 220, different from those in the first example embodiment of the present disclosure, will be described, and the descriptions of the remaining components in the first example embodiment of the present disclosure may be applied in the same manner.

Referring to FIGS. 7 to 9, at least one of the first and second lead-out portions 210 and 220 of the coil component 2000 according to the present exemplary embodiment may be spaced apart from the pad portions 330 and 430.

Specifically, at least one of the first lead-out portion 210 and the second lead-out portion 220 may be disposed so as not to extend to the third surface 103 of the body 100. As a result, the lead-out portions 210 and 220 may be formed to be shorter than those of the coil component 1000 according to the first example embodiment.

In the coil component 2000 according to the present example embodiment, the lead-out portions 210 and 220 may not be disposed on the third surface 103 of the body 100, the pad portions 330 and 430 may be in closer contact with the third surface 103 of the body 100 by a thickness of each of the lead-out portions 210 and 220, which may be advantageous in reducing an overall thickness of the coil component 2000.

In addition, assuming that a length of each of the extension portions 320 and 420 is the same as that in the example first embodiment, a larger effective volume may be secured for the arrangement of a magnetic material in the body 100, thereby improving inductance characteristics.

### Experimental Data

FIGS. 10 to 15 are graphs illustrating a relationship between a mass of the coil component 1000 and an average length of the extension portion according to a first exemplary embodiment of the present disclosure, and illustrate result values according to respective natural frequencies while adjusting an average width and average thickness of the extension portion.

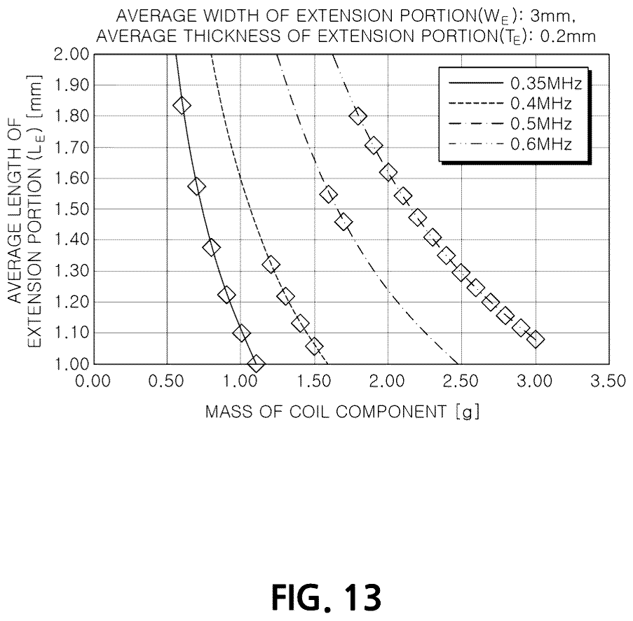

FIGS. 10 to 12 are graphs illustrating an average length of an extension portion according to a mass of a coil component when an average thickness of the extension portion is 0.15 mm. FIGS. 13 to 15 are graphs illustrating an average length of an extension portion according to a mass of a coil component when an average thickness of the extension portion is 0.2 mm.

TABLE 1

| | Average Thickness (T_{E}) of Extension Portion | | |
|---|---|---|---|
| | 0.15 mm | | |
| | Average Width (W_{E}) of Extension Portion | | |
| Mass (m)[g] of | 3 mm | 4.2 mm | 4.7 mm |
| Coil Component | Average Length (L_{E})[mm] of Extension Portion | | |
| 0.50 | 1.65 | — | — |
| 0.60 | 1.38 | 1.93 | — |
| 0.70 | 1.18 | 1.65 | 1.85 |
| 0.80 | 1.03 | 1.45 | 1.62 |
| 0.90 | 1.32 | 1.29 | 1.44 |
| 1.00 | 1.19 | 1.16 | 1.30 |
| 1.10 | 1.08 | 1.05 | 1.18 |
| 1.20 | 1.55 | 1.39 | 1.08 |
| 1.30 | 1.43 | 1.28 | 1.44 |
| 1.40 | 1.33 | 1.19 | 1.33 |
| 1.50 | 1.24 | 1.11 | 1.24 |
| 1.60 | 1.16 | 1.04 | 1.17 |
| 1.70 | 1.09 | 1.53 | 1.10 |
| 1.80 | 1.03 | 1.45 | 1.04 |
| 1.90 | 1.28 | 1.37 | 1.53 |
| 2.00 | 1.22 | 1.30 | 1.46 |
| 2.10 | 1.16 | 1.24 | 1.39 |
| 2.20 | 1.10 | 1.18 | 1.33 |
| 2.30 | 1.06 | 1.13 | 1.27 |
| 2.40 | 1.01 | 1.09 | 1.21 |
| 2.50 | — | 1.04 | 1.17 |
| 2.60 | — | 1.00 | 1.12 |
| 2.70 | — | 1.26 | 1.08 |
| 2.80 | — | 1.22 | 1.04 |
| 2.90 | — | 1.17 | 1.01 |
| 3.00 | — | 1.13 | 1.27 |
| 3.10 | — | — | 1.23 |

Referring to FIGS. 10 to 12 and Table 1, an average length (L_{E}) of each of the extension portions 320 and 420 in a second direction T may decrease as a mass (m) of the coil component increases. Thus, it may be seen that the average length (L_{E}) of each of the extension portions 320 and 420 in the second direction T may be inversely proportional to the mass (m) of the coil component.

In addition, in Table 1, an average width (W_{E}) of each of the extension portions 320 and 420 in the second direction T may increase in a state in which an average thickness (T_{E}) of each of the extension portions 320 and 420 is fixedly set to 0.15 mm. Accordingly, it may be seen that an average length (L_{E}) of each of the extension portions 320 and 420 in the second direction T is proportional to a cross-sectional area (A) of each of the extension portions 320 and 420 in a cross-section, perpendicular to the second direction T.

TABLE 2

| | Average Thickness (T_{E}) of Extension Portion | | |
|---|---|---|---|
| | 0.20 mm | | |
| | Average Width (W_{E}) of Extension Portion | | |
| Mass (m)[g] of | 3 mm | 4.2 mm | 4.7 mm |
| Coil Component | Average Length (L_{E})[mm] of Extension Portion | | |
| 0.60 | 1.84 | — | — |
| 0.70 | 1.58 | — | — |
| 0.80 | 1.38 | 1.93 | — |
| 0.90 | 1.23 | 1.72 | 1.92 |
| 1.00 | 1.10 | 1.54 | 1.73 |
| 1.10 | 1.00 | 1.40 | 1.57 |
| 1.20 | 1.32 | 1.29 | 1.44 |
| 1.30 | 1.22 | 1.19 | 1.33 |
| 1.40 | 1.13 | 1.10 | 1.23 |
| 1.50 | 1.06 | 1.03 | 1.15 |
| 1.60 | 1.55 | 1.39 | 1.08 |
| 1.70 | 1.46 | 1.31 | 1.02 |
| 1.80 | 1.80 | 1.24 | 1.38 |
| 1.90 | 1.71 | 1.17 | 1.31 |
| 2.00 | 1.62 | 1.11 | 1.24 |
| 2.10 | 1.54 | 1.06 | 1.18 |
| 2.20 | 1.47 | 1.01 | 1.13 |
| 2.30 | 1.41 | 1.51 | 1.08 |
| 2.40 | 1.35 | 1.45 | 1.04 |
| 2.50 | 1.30 | 1.39 | 1.55 |
| 2.60 | 1.25 | 1.34 | 1.50 |
| 2.70 | 1.20 | 1.29 | 1.44 |
| 2.80 | 1.16 | 1.24 | 1.39 |
| 2.90 | 1.12 | 1.20 | 1.34 |
| 3.00 | 1.08 | 1.16 | 1.30 |
| 3.10 | — | 1.12 | 1.25 |
| 3.20 | — | 1.09 | 1.21 |
| 3.30 | — | 1.05 | 1.18 |
| 3.40 | — | 1.02 | 1.14 |
| 3.50 | — | 1.30 | 1.11 |
| 3.60 | — | 1.26 | 1.08 |
| 3.70 | — | 1.23 | 1.05 |
| 3.80 | — | 1.19 | 1.02 |
| 3.90 | — | 1.16 | 1.30 |
| 4.00 | — | 1.13 | 1.27 |

Referring to FIGS. 13 to 15 and Table 2, an average length (L_{E}) of each of the extension portions 320 and 420 in a second direction T may decrease as a mass (m) of the coil component increases. Thus, it may be seen that the average length (L_{E}) of each of the extension portions 320 and 420 in the second direction T may be inversely proportional to the mass (m) of the coil component.

In addition, in Table 2, an average width (W_{E}) of each of the extension portions 320 and 420 in the second direction T may increase in a state in which an average thickness (T_{E}) of each of the extension portions 320 and 420 is fixedly set to 0.15 mm. Accordingly, it may be seen that an average length (L_{E}) of each of the extension portions 320 and 420 in the second direction T is proportional to a cross-sectional area (A) of each of the extension portions 320 and 420 in a cross-section, perpendicular to the second direction T.

In addition, comparing Table 1 and Table 2 with each other, when the average thickness (T_{E}) of each of the extension portions is increased to 0.2 mm in a state in which the mass (m) of the coil component and the average width (W_{E}) of each of the extension portions are fixed, the average length (L_{E}) of each of the extension portions 320 and 420 in the second direction T may increase. Thus, it may be seen that the average length (L_{E}) of each of the extension portions 320 and 420 in the second direction T is also proportional to the cross-sectional area (A) of each of the extension portions 320 and 420 in the cross-section, perpendicular to the second direction T.

While example embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface opposing each other in a first direction, and a third surface and a fourth surface opposing each other in a second direction, perpendicular to the first direction;
a coil disposed in the body, the coil including a first lead-out portion that extends to the first surface and a second lead-out portion that extends to the second surface; and
a first external electrode connected to the first lead-out portion, and a second external electrode connected to the second lead-out portion,
wherein the first and the second external electrodes include an insertion portion having at least a portion disposed in the body, an extension portion bent from the insertion portion, the extension portion extending in the second direction, and a pad portion bent from the extension portion, the pad portion extending to the third surface, and
an average length of the extension portion in the second direction is 0.5 times or less of an average thickness of the body in the second direction, and is inversely proportional to a mass of the coil component.

2. The coil component of claim 1, wherein the average length of the extension portion in the second direction and the mass of the coil component satisfy the following equation,
$${L}_{E} = \frac{E}{4 {π}^{2} \times {f}^{2}} \times \frac{2 A}{m} \qquad [ Equation ]$$
where L_{E} denotes the average length of the extension portion, E denotes an elastic modulus, f denotes a natural frequency, A denotes a cross-sectional area of the extension portion, and m denotes the mass of the coil component.

3. The coil component of claim 2, wherein the natural frequency (f) of the equation is greater than 0.2 MHz.

4. The coil component of claim 1, wherein the insertion portion includes a protrusion portion protruding in a third direction, perpendicular to the first and the second directions.

5. The coil component of claim 1, wherein an opening is formed in at least a portion of a bent region between the insertion portion and the extension portion and a bent region between the extension portion and the pad portion.

6. The coil component of claim 1, wherein the first lead-out portion is disposed between the body and the first external electrode, and the second lead-out portion is disposed between the body and the second external electrode.

7. The coil component of claim 6, further comprising:
a metal layer covering the first and the second lead-out portions.

8. The coil component of claim 7, wherein the metal layer includes at least one of Sn, Ni, and Cu.

9. The coil component of claim 1, wherein
the first surface and the second surface are connected to each other via the third surface,
wherein a recess is formed in each of a region where the first surface and the third surface meet, and a region where the second surface and the third surface meet, and
the extension portion and the pad portion are disposed in the recess.

10. The coil component of claim 9, wherein the first and the second lead-out portions extend to the third surface along a surface of the recess.

11. The coil component of claim 9, wherein at least one of the first and the second lead-out portions is spaced apart from the pad portion.

12. The coil component of claim 1,
wherein the average length (L_{E}) of the extension portion in the second direction is proportional to a cross-sectional area (A) of the extension portion in a cross-section perpendicular to the second direction.

13. A coil component comprising:
a body including a first surface and a second surface opposing each other in a first direction, and a third surface and a fourth surface opposing each other in a second direction, perpendicular to the first direction;
a coil disposed in the body, the coil including a first lead-out portion that extends to the first surface and a second lead-out portion that extends to the second surface; and
a first external electrode connected to the first lead-out portion, and a second external electrode connected to the second lead-out portion,
wherein the first and the second external electrodes include an insertion portion having at least a portion disposed in the body, an extension portion bent from the insertion portion, the extension portion extending in the second direction, and a pad portion bent from the extension portion, the pad portion extending to the third surface, and
an average length of the extension portion in the second direction is 0.5 times or less of an average thickness of the body in the second direction, and is proportional to a cross-sectional area of the extension portion in a cross-section, perpendicular to the second direction.

14. The coil component of claim 13, wherein
the body further includes a fifth surface and a sixth surface opposing each other in a third direction, perpendicular to the first and the second directions, and
the cross-sectional area of the extension portion is defined as a product of an average thickness of the extension portion in the first direction and an average width of the extension portion in the third direction in the cross-section, perpendicular to the second direction.

15. The coil component of claim 13, wherein the average length of the extension portion in the second direction and the cross-sectional area of the extension portion in the cross-section, perpendicular to the second direction, satisfy the following equation,
$${L}_{E} = \frac{E}{4 {π}^{2} \times {f}^{2}} \times \frac{2 A}{m} \qquad [ Equation ]$$
where L_{E} denotes the average length of the extension portion, E denotes an elastic modulus, f denotes a natural frequency, A denotes the cross-sectional area of the extension portion, and m denotes a mass of the coil component.

16. The coil component of claim 15, wherein the natural frequency (f) of the equation is greater than 0.2 MHz.

17. The coil component of claim 13, wherein the first lead-out portion is disposed between the body and the first external electrode, and the second lead-out portion is disposed between the body and the second external electrode.

18. The coil component of claim 17, further comprising:
a metal layer covering the first and the second lead-out portions,
wherein the metal layer includes at least one of Sn, Ni, and Cu.

19. The coil component of claim 13, wherein
the first surface and the second surface are connected to each other via the third surface,
wherein a recess is formed in each of a region where the first surface and the third surface meet, and a region where the second surface and the third surface meet, and
the extension portion and the pad portion are disposed in the recess.

20. The coil component of claim 19, wherein each of the first and the second lead-out portions extends to the third surface along a surface of the recess.

21. The coil component of claim 19, wherein at least one of the first and the second lead-out portions is spaced apart from the pad portion.

22. The coil component of claim 13,
wherein the average length (L_{E}) of the extension portion in the second direction is proportional to a cross-sectional area (A) of the extension portion in a cross-section perpendicular to the second direction.
